(19) United States
(12) Patent Application Publication
(10) Pub. No.: US 2021/0188729 A1
(43) Pub. Date: Jun. 24, 2021

(54) ORGANIC MANURE

(71) Applicant: Surajit Sen, Kolkata (IN)

(72) Inventor: Surajit Sen, Kolkata (IN)

(21) Appl. No.: 16/721,849

(22) Filed: Dec. 19, 2019

(51) Int. Cl. C05G 1/00; C05F 17/05; C05F 11/08; C05F 11/02; C05F 5/00; C05D 9/00; C05B 17/00

(52) U.S. Cl. CPC C05G 1/00; C05F 17/05; C05F 11/08; C05B 17/00; C05F 5/002; C05D 9/00; C05F 11/02

(57) ABSTRACT

The present invention is an organic manure which is prepared by mixing or blending natural ingredients along with sufficient amount of nitrogen, phosphorous and potassium and other micro-nutrients. Moreover, this invention also relates to the process of preparing the above organic manure.

### FIELD OF THE INVENTION

The present invention relates to organic manure. More particularly, the present invention relates to the organic manure which is prepared by mixing of natural ingredients along with sufficient amount of nitrogen, phosphorous and potassium and other micro-nutrients. Moreover, this invention also relates to the process of preparing the above organic manure.

### BACKGROUND OF THE INVENTION

It is generally believed that trees are able to obtain all their nutrients and water from the soil. While this is possible under ideal conditions, very often growing conditions are not ideal, which leads to poor growth. To enhance their chances for survival, the roots of trees and soil organisms have developed a symbiotic existence. The trees manufacture by photosynthesis and donate energy, in the form of sugars, to the microorganisms, which then employ the sugars to decompose organic matter and rocks to release nutrients. Such decomposition results in more nutrients than the microorganisms need, and the excess is transferred to feeder roots of the tree. In this way, difficult to obtain nutrients, such as phosphorus and micronutrients, are obtained by the roots.

Rice and potato are the staple food of about two-third population of our country and contribute a major energy source for human community. It is a fact that both the crops are very exhaustive in nature and exert tremendous pressure on soil health. This simulate the need for utmost care in attaining a delicate balance among various source of inputs with special attention to nutrient management through conjunctive use of organic and inorganic sources of plant nutrients to sustain the crop productivity and soil fertility. The review on the current study entitled Effect of integrated nutrient management in rice-potato cropping system is an attempt to provide an insight to state of research conducted elsewhere. Cropping systems-based approach was felt essential only during last two decades to sustain crop productivity levels attained through high yielding modern varieties and improved agro-techniques. Efficient cropping systems with respect to biological potential and efficiencies of land, water and nutrient use are to be identified to increase resource use efficiency of a multiple cropping systems. Multiple cropping with diversified crops should be followed by integrated management of different inputs of crop production.

The document U.S. Pat. No. 8,029,593 discloses biofertilizers have been identified as an alternative to chemical fertilization to increase soil fertility and crop production using sustainable farming. Treatment is with at least a proprietary formulation of a nitrogen-fixing consortium and Azospirillum brasilense. The application of biofertilizers resulted in higher biomass compared to chemical fertilizer treatment. Chlorophyll and nitrogen levels in these grass plants are also likely to be improved.

The document WO2013078365 relates to a fertilizer comprising at least one microbe selected from the group consisting of Trichoderma viride (NRRL B-50520), Scopulariopsis brevicaulis (NRRL B-50521), Scopulariopsis brevicaulis (NRRL B-50522), and combinations thereof, and a substrate which is acted upon by the at least one microbe to release nitrogen. The invention also relates to a fertilizer comprising at least one microbe selected from a keratin degrading microorganism and a keratin substrate which is acted upon by the at least one microbe to release nitrogen. The invention further relates to a method for enhancing growth of plants with the fertilizer, and methods of making a fertilizer. The invention further relates to an isolated Trichoderma viride strain (NRRL B-50520) and two isolated Scopulariopsis brevicaulis strains (NRRL B-50521, NRRL B-50522).

The document U.S. Pat. No. 6,994,850 provides a method for preparing a biological fertilizer composition that comprises yeast cells and swine manure. The yeast cells of the invention have an enhanced ability to fix atmospheric nitrogen, decompose phosphorus minerals and compounds, decompose potassium minerals and compounds, decompose complex carbon compounds, overproduce growth factors, overproduce ATP, decompose undesirable chemicals, suppress growth of pathogenic microorganisms, or reduce undesirable odor.

According to the document U.S. Pat. No. 6,273,927, a method of manufacturing the fertilizer made from organic wastes such as food wastes, human excrements, animal excrements, slaughterhouse waste, henhouse waste, fish and shellfish wastes, vegetable wastes and agricultural wastes. Various wastes are mixed and crushed into certain sizes, processes for adjusting the water content, put into the treating tank and digested by mixing a calcined lime. The present invention utilizes a dolomite or mixture of calcined lime and dolomite to provide the first treatment material. This first treatment material is mixed with the supplement material such as charcoal, saw dust, loess, zeolite, chaff, or shell powder to give compost fertilizer. It is also mixed with agricultural products such a watermelons or melons which ferment to provide a special fertilizer for the agricultural product. The treatment material can be added to water and mixed with mugwort, medicinal herb, zeolite, loess, and then extracted to provide a liquid fertilizer. As the various organic wastes are changed to organic fertilizer, the acidified soil is improved, the environmental contamination can be prevented, and the high moisturizing and the fine porous of the soil prevent drought and fertilizer loss so as to raise fertilizing efficiency.

The document U.S. Pat. No. 6,852,142 provides methods for producing homogenous organic base fertilizer for plant nutrition and soil fertility. Also provided by the subject invention are value added fertilizer products for plant nutrition and soil fertility and concentrated liquid formulations/nutrient supplements that provide the value-added nutrients to fertilizer products. Methods according to the invention involve the application of concentrated liquid(s) and/or dry formulation(s) comprising a mixture of one or more plant nutrient(s), one or more additional organic compound(s), one or more penetrate(s), and one or more optional supplement(s) into one or more organic base material(s). These organic base materials include, and are not limited to, biosolids, activated sludge, municipal compost, animal manures (e.g., horse, cow, chicken, pig, and sheep), and composted organic byproducts.

The document WO2013098856, a storage/shelf stable activity enhancing biofertilizer formulation/composition comprising earthworm cocoons and microorganism selected from Azotobacter and/or other Nitrogen-fixing bacteria in the presence of a bio compatible carrier synergistically facilitating increased activity of said microorganisms thus aiding in increased fertility of the soil. A storage stable biofertilizer formulation/composition comprising selectively encapsulated/coated earthworm cocoons involving non-steamed rice grain paste based encapsulation/coating material for extended storage stability and viability even after at least 12 weeks post application and its process of encapsulation thereof.

In the document CN105523810, the invention relates to the field of preparation of fertilizers, and discloses a seaweed Azotobacter fertilizer preparation method, fresh seaweed is chopped, and mixed into a nutritional supplement for even mixing to prepare a solid fermentation matrix, an Azotobacter seed liquid is inoculated for solid fermentation, low-temperature drying and crushing to prepare a seaweed Azotobacter fertilizer. By seaweed solid fermentation technique, Azotobacter and a seaweed fertilizer are organically combined, active ingredients of the seaweed can be converted by the Azotobacter, better plant growth-promoting effect is played, meanwhile the Azotobacter in the seaweed Azotobacter fertilizer can supplement nitrogen for plant roots by nitrogen fixation effect, during growth and reproduction process of the Azotobacter, a large number of extracellular polysaccharides are secreted, and the extracellular polysaccharides are an adhesive for formation of a soil aggregate structure and maintaining of the stability of the aggregates, the soil compaction phenomenon caused by the long-term excessive application of inorganic fertilizers can be overcome, and long-term sustainable development of ecological agriculture can be promoted.

The document WO2008155514 relates to a plant growth promoting composition includes beneficial microbes and microbial activators. The beneficial microbes may include Bacillus spp., Azotobacter spp., Trichoderma spp., Saccharomyches spp., or combinations of these, the microtrial activators include enzymes, metabolites, carbohydrate yeast, humic material, starch, amino acids and micronutrients. The plant growth promoting composition may also include organic and inorganic fertilizers.

The document U.S. Pat. No. 5,478,373 describes trees that are fertilized with natural ingredients commonly used in the feed industry to prevent, combat and reverse die-back damage in trees. The fertilizer composition employed preferably uses feather meal or blood meal, and bone meal, along with sulfate of potash or sulfate of potash magnesia to provide a ratio of N:P:K of about 4:4:8 wt. %. As the microorganism population declines as a result of a decrease in available energy, the roots of the tree cannot feed the whole canopy of the tree, resulting in the initiation of die-back. Prior to the inventor's discovery thereof, it is thought that the mechanism of die-back of trees as outlined above was not understood, although several theories had been proposed. No known chemical fertilizer is able to prevent or cure the problem.

### SUMMARY OF THE INVENTION

The present invention relates to organic manure. More particularly, the present invention relates to the organic manure which is prepared by mixing of natural ingredients along with sufficient amount of nitrogen, phosphorous and potassium and other micronutrients. Moreover, this invention also relates to the process of preparing the above organic manure.

### DETAILED DESCRIPTION OF THE INVENTION

The improved soil amendment increases the effectiveness of the fertilizer by significantly reducing leaching of the fertilizer from the root zone. This makes the fertilizer available to the plant longer and reduces the negative impact conventional fertilizer applications have on the environment. The improved soil amendment changes the primary leaching mechanism within the soil profile from gravity to osmotic influenced leaching.

The object of the present invention is to provide organic manure.

Still other object of the present invention is to provide the organic manure which is prepared by the mixing of vermi compost, Azolla, Sesbania plant chopped, wood charcoal, powder, Azotobacter, Azospirillum, Zinc solubilizing bacteria, Phosphate solubilizing bacteria, Potassium solubilizing bacteria, Trichoderma harzianum, Pseudomonas fluorescens, Vesicular Arbuscular mycorrhizae, Bone Meal, potassium Humate power (85%), Bio Fulvic powder, organic seaweed extract powder, and Metarhizium anisopliae.

Still another object of the present invention is to provide the organic manure which is prepared by blending of vermi compost 500 g, Azolla 51 g, Sesbania plant chopped 100 g, wood charcoal powder 100 g, Azotobacter 27 g, Azospirillum 27 g, Zinc solubilizing bacteria 7 g, Phosphate solubilizing bacteria 7 g, Potassium solubilizing bacteria 7 g, Trichoderma harzianum 14 g, Pseudomonas fluorescens 14 g, Vesicular Arbuscular mycorrhizae 17 g, Bone Meal 5 g, potassium Humate power (85%) 70 g, Bio Fulvic powder 20 g, organic seaweed extract powder 20 g, and Metarhizium anisopliae 14 g in 1000 g of manure.

The composition of the invention employs natural components, in contrast to chemical fertilizers commonly used. As noted above, there is no known chemical fertilizer able to achieve the results obtained herein. The composition of the invention is slow release, long-lasting, non-burning to trees and contains micronutrients.

Furthermore, another object of this invention relates to the process for the preparation of the above composition of organic manure which is prepared by mixing or blending: vermi compost 500 g, Azolla 51 g, Sesbania plant chopped 100 g, wood charcoal powder 100 g, Azotobacter 27 g, Azospirillum 27 g, Zinc solubilizing bacteria 7 g, Phosphate solubilizing bacteria 7 g, Potassium solubilizing bacteria 7 g, Trichoderma harzianum 14 g, Pseudomonas fluorescens 14 g, Vesicular Arbuscular mycorrhizae 17 g, Bone Meal 5 g, potassium Humate power (85%) 70 g, Bio Fulvic powder 20 g, organic seaweed extract powder 20 g, and Metarhizium anisopliae 14 g in 1000 g of manure.

The present invention to provide the organic manure which is prepared by the mixing of 50% of vermi compost, 5.1% of Azolla, 10% of Sesbania plant chopped, 10% of wood charcoal, powder, 2.7% of Azotobacter, 2.7% of Azospirillum, 0.7% of Zinc solubilizing bacteria, 0.7% of Phosphate solubilizing bacteria, 0.7% of Potassium solubilizing bacteria, 1.4% of Trichoderma harzianum, 1.4% of Pseudomonas fluorescens, 1.7% of Vesicular Arbuscular mycorrhizae, 0.5% of Bone Meal, 7.0% of potassium Humate power (85%), 2% of Bio Fulvic powder, 2% of organic seaweed extract powder, and 1.4% of Metarhizium anisopliae for a total of 100% by weight of manure.

Application of inorganic fertilizers alone year after year not only has deleterious effect on soil but also has negative impact on the quality of produce. In most of the rice-based cropping systems, the removal of nutrients often exceeds the amount of nutrients applied. The organic manure of the present invention will provide an equal amount of plant nutrients to any crop without damaging the fertility of the agricultural soil. The fertility of the agricultural soil will increase day by day after repetitive use of this manure on the same soil. The organic manure of the invention is an eco-friendly fertilizer with no negative impact to under-ground drinking water as well as in air pollution unlike chemical fertilizers. The organic manure is 100% pure mixture of organic cum bio fertilizer that has the ability to give an equal amount of vegetative growth of all plants and generate an equal amount of agricultural yields regardless of any crop whatsoever in future. This manure will increase the water holding capacity of the soil and will minimize the evaporation losses of moisture from the soil which will surely save our planet in the future by reducing water consumption during cultivation of any crops.

The efficacy of the present invention lies in the formulation of the composition of the ingredients in a particular ratio which is highly significant as shown by the examples herein below.

Different combinations have been tried which are illustrated by the following examples. Out of five examples given below, example V is found to be most suitable because it obviates the drawbacks.

### Example I

The organic manure is prepared by blending or mixing: vermi compost 200 g, Azolla 51 g, Sesbania plant chopped 400 g, wood charcoal powder 100 g, Azotobacter 27 g, Azospirillum 25 g, Zinc solubilizing bacteria 9 g, Phosphate solubilizing bacteria 7 g, Potassium solubilizing bacteria7 g, Trichoderma harzianum 14 g, Pseudomonas fluorescens 14 g, Vesicular Arbuscular mycorrhizae 17 g, Bone Meal 5 g, potassium Humate power (85%) 70 g, Bio Fulvic powder 25 g, organic seaweed extract powder 15 g, and Metarhizium anisopliae 14 g in 1000 g of manure.

### Example II

The organic manure is prepared by blending or mixing: vermi compost 100 g, Azolla 51 g, Sesbania plant chopped 500 g, wood charcoal powder 100 g, Azotobacter 27 g, Azospirillum 31 g, Zinc solubilizing bacteria 3 g, Phosphate solubilizing bacteria 7 g, Potassium solubilizing bacteria7 g, Trichoderma harzianum 14 g, Pseudomonas fluorescens 20 g, Vesicular Arbuscular Mycorrhizae 11 g, Bone Meal 5 g, potassium Humate power (85%) 70 g, Bio Fulvic powder 20 g, organic seaweed extract powder 20 g, and Metarhizium anisopliae 14 g in 1000 g of manure.

### Example III

The organic manure is prepared by blending or mixing: vermi compost 200 g, Azolla 51 g, Sesbania plant chopped 400 g, wood charcoal powder 100 g, Azotobacter 27 g, Azospirillum 20 g, Zinc solubilizing bacteria 14 g, Phosphate solubilizing bacteria7 g, Potassium solubilizing bacteria7 g, Trichoderma harzianum 14 g, Pseudomonas fluorescens 24 g, Vesicular Arbuscular mycorrhizae 7 g, Bone Meal 5 g, potassium Humate power (85%) 70 g, Bio Fulvic powder 20 g, organic seaweed extract powder 20 g, and Metarhizium anisopliae 14 g in 1000 g of manure.

### Example IV

The organic manure is prepared by blending or mixing: vermi compost 500 g, Azolla 51 g, Sesbania plant chopped 100 g, wood charcoal powder 100 g, Azotobacter 27 g, Azospirillum 20 g, Zinc solubilizing bacteria 14 g, Phosphate solubilizing bacteria 7 g, Potassium solubilizing bacteria 7 g, Trichoderma harzianum 10 g, Pseudomonas fluorescens 18g, Vesicular Arbuscular mycorrhizae 17 g, Bone Meal 5 g, potassium Humate power (85%) 50 g, Bio Fulvic powder 40 g, organic seaweed extract powder 30 g, and Metarhizium anisopliae 4 g in 1000 g of manure.

### Example V

The organic manure is prepared by blending or mixing: vermi compost 500 g, Azolla 51 g, Sesbania plant chopped 100 g, wood charcoal powder 100 g, Azotobacter 27 g, Azospirillum 27 g, Zinc solubilizing bacteria 7 g, Phosphate solubilizing bacteria 7 g, Potassium solubilizing bacteria 7 g, Trichoderma harzianum 14 g, Pseudomonas fluorescens 14 g, Vesicular Arbuscular mycorrhizae 17 g, Bone Meal 5 g, potassium Humate power (85%) 70 g, Bio Fulvic powder 20 g, organic seaweed extract powder 20 g, and Metarhizium anisopliae 14 g in 1000 g of manure.

The results of this study showed that this particular novel combination organic manure as stated in example V can make a significant difference in their own way mostly with more amount of nitrogenous fertilizer than P and K, at times even without P and K. To have a balanced fertilizer schedule it is advised to adopt simultaneous use of organic, inorganic and bio-fertilizers to sustain the system productivity of various crop sequences as well as to maintain the soil fertility and productivity.

According to a preferred embodiment, the ingredients are mixed or blended in a double helix ribbon blender until a homogeneous mix of different organic and natural and bio ingredients is formed. Preferably, the ingredients are mixed or blended for about an hour. However, any mixing or blended method and/or apparatus can be used as long as a resulting homogeneous mixture is achieved.

Obviously, many modifications and variations of the invention, as defined above, can be made without departing from the spirit and scope thereof, and therefore only such limitations should be imposed as are indicated in the appended claims.

I claim:

1) An organic manure composition comprising an effective amount of the following ingredients: vermi compost, Azolla, chopped Sesbania plant, wood charcoal powder, Azotobacter, Azospirillum, Zinc-solubilizing bacteria, Phosphate-solubilizing bacteria, Potassium-solubilizing bacteria, Trichoderma harzianum, Pseudomonas fluorescens, Vesicular Arbuscular mycorrhizae, Bone Meal, potassium Humate power (85%), Bio Fulvic powder, organic seaweed extract powder, and Metarhizium anisopliae.

2) The organic manure composition according to claim 1, comprising: 500 g of vermi compost, 51 g of Azolla, 100 g of chopped Sesbania plant, 100 g of wood charcoal powder, 27 g of Azotobacter, 27 g of Azospirillum, 7 g of Zinc-solubilizing bacteria, 7 g of Phosphate-solubilizing bacteria, 7 g of Potassium-solubilizing bacteria, 14 g of Trichoderma harzianum, 14 g of Pseudomonas fluorescens, 17 g of Vesicular Arbuscular mycorrhizae, 5 g of Bone Meal, 70 g of potassium Humate power (85%), 20 g of Bio Fulvic powder, 20 g of organic seaweed extract powder, and 14 g of Metarhizium anisopliae.

3) The organic manure composition according to claim 1, comprising: 50% by weight of vermi compost, 5.1% by weight of Azolla, 10% by weight of chopped Sesbania plant, 10% by weight of wood charcoal powder, 2.7% by weight of Azotobacter, 2.7% by weight of Azospirillum, 0.7% by weight of Zinc-solubilizing bacteria, 0.7% by weight of Phosphate-solubilizing bacteria, 0.7% by weight of Potassium-solubilizing bacteria, 1.4% by weight of Trichoderma harzianum, 1.4% by weight of Pseudomonas fluorescens, 1.7% by weight of Vesicular Arbuscular mycorrhizae, 0.5% by weight of Bone Meal, 7.0% by weight of potassium Humate power (85%), 2% by weight of Bio Fulvic powder, 2% by weight of organic seaweed extract powder, and 1.4% by weight of Metarhizium anisopliae.

4) A process for preparing the organic manure composition of claim 1, comprising: mixing or blending said ingredients.

5) A process for preparing the organic manure composition of claim 2, comprising mixing or blending said ingredients.

6) A process for preparing the organic manure composition of claim 3, comprising mixing or blending said ingredients.
